(19) United States
(12) Patent Application Publication
(10) Pub. No.: US 2014/0037537 A1
(43) Pub. Date: Feb. 6, 2014

(54) COKE TOLERANT STEAM REFORMING CATALYST

(71) Applicants: Lucas Donald Dorazio, Belford, NJ (US); Robert Farrauto, Princeton, NJ (US)

(72) Inventors: Lucas Donald Dorazio, Belford, NJ (US); Robert Farrauto, Princeton, NJ (US)

(73) Assignee: BASF Corporation, Florham Park, NJ (US)

(21) Appl. No.: 13/565,089

(22) Filed: Aug. 2, 2012

(51) Int. Cl. C01B 3/40; B01J 23/63

(52) U.S. Cl. 423/652; 502/304

(57) ABSTRACT

Steam reforming a hydrocarbon feed such as liquefied petroleum gas is conducted in the presence of a catalyst comprising a precious metal such as rhodium on a support comprising ceria, zirconia and praseodymium oxide.

### FIELD OF THE INVENTION

The present invention relates to a catalyst for use in reforming of hydrocarbons (hereinafter referred to as a hydrocarbon reforming catalyst), and to a method for producing hydrogen by use of the reforming catalyst.

### BACKGROUND OF THE INVENTION

In recent years, new energy-production techniques have attracted attention from the standpoint of environmental issues, and among these techniques a fuel cell has attracted particular interest. The fuel cell converts chemical energy to electric energy through electrochemical reaction of hydrogen and oxygen, attaining high energy utilization efficiency. Therefore, extensive studies have been carried out on realization of fuel cells for public use, industrial use, automobile use, etc.

Fuel cells are categorized in accordance with the type of employed electrolyte, and, among others, a phosphoric acid type, a molten carbonate salt type, a solid oxide type, and a polymer electrolyte type have been known. With regard to hydrogen sources, studies have been conducted on methanol; liquefied natural gas predominantly containing methane; city gas predominantly containing natural gas; a synthetic liquid fuel produced from natural gas serving as a feedstock; and petroleum-derived hydrocarbons such as naphtha and kerosene.

When hydrogen is produced from petroleum-derived hydrocarbons, the hydrocarbons are generally steam-reformed in the presence of a catalyst. Among such catalysts, catalysts that contain rhodium supported on a carrier as an active component have conventionally been studied, in view of their advantages; e.g., comparatively high activity and suppression of carbon deposition even under low steam/carbon ratio operational conditions. In recent years, these rhodium catalysts have been envisaged for use in fuel cells, which require a long-life catalyst.

Over the coming decade, fuel cell systems are expected to become more common as a source of electrical and thermal energy for a variety of stationary applications. Where available, natural gas will be the preferred fuel to be steam reformed to synthesis gas for the fuel cell. Where natural gas is not available, liquefied fuels will be used such as liquefied petroleum gas (LPG), or even heavier logistic fuels. One issue associated with steam reforming hydrocarbons to produce synthesis gas is the accumulation of coke that leads to catalyst deactivation. Coke accumulation will be an issue associated with any fuel containing “coke precursors”, such as olefins, heavy hydrocarbons, and aromatics. While primarily composed of methane, natural gas quality varies around the globe and it is possible for small concentrations of olefins and heavy hydrocarbons to be present. Liquefied Petroleum Gas (LPG) compositions vary widely and it is common to find olefins in relatively high concentrations in commercial grade LPG. It has been found that traditional base-metal catalysts (i.e. Ni-based catalysts) have a significantly higher tendency for coke accumulation than precious metal based catalysts. Successful commercial development of fuel cell systems will require the development of new catalysts in concert with reaction conditions that are tolerant to coke accumulation.

As above noted, when steam reforming fuels containing coke precursors, coke accumulation on the catalyst surface and subsequent catalyst deactivation is an issue. One solution to this issue is to operate the steam reformer at either a high temperature or high steam concentration. Another solution is to perform autothermal steam reforming (ATR). However, either case has a significant negative impact on the efficiency of reformer and is undesired. The objective of work behind this invention was to develop a new steam reforming catalyst that has a lower tendency for coke accumulation (more coke tolerant), thus allowing stable catalyst operation at a lower, more favorable reaction temperature and steam concentration.

This invention involves a modification to the catalyst carrier that reduces the tendency for coke to accumulate on the catalyst surface. Prior to this invention, the state of the art catalyst comprised of precious metals dispersed into a matrix of alumina and ceria-zirconia.

### SUMMARY OF THE INVENTION

In this invention, the alumina/ceria-zirconia matrix has been replaced with a carrier matrix comprised of ceria-zirconia-praseodymium (CZP). Unexpectedly, it has been observed that the addition of Pr to a Ce—Zr matrix has yielded a more coke tolerant catalyst than the combinations of ceria-zirconia, alumina/ceria-zirconia or ceria by itself.

### BRIEF DESCRIPTION OF THE DRAWINGS

The FIGURE is a bar graph comparing the stability of various steam reforming catalysts aged for 16 hours.

### DETAILED DESCRIPTION OF THE INVENTION

In accordance with this invention, steam reforming of hydrocarbons containing coke precursors is advantageously conducted in the presence of a catalyst containing a precious metal contained on support compositions that correspond to the formula:

CeₓZr_{y}Pr_{z}O₂

wherein z exhibits a value which can be between 0.02 and 0.5 and, for these values of z, the x/y ratio can be between 1 and 19, more particularly between 1 and 9 and more particularly still between 1.5 and 4, and x, y and z being linked by the relationship x+y+z=1. Values of z can also range from 0.1 to 0.3, and further from 0.2 to 0.3.

The support compositions of the invention can advantageously exist in the form of a solid solution. The X-ray diffraction spectra of these compositions in fact reveal, within the latter, the existence of a single homogenous phase. For the compositions which are the richest in cerium, this phase corresponds in fact to that of a crystalline ceric oxide CeO₂, the unit cell parameters of which are more or less offset with respect to a pure ceric oxide, thus reflecting the incorporation of zirconium and praseodymium in the crystal lattice of the cerium oxide and thus the preparation of a true solid solution.

The process for the preparation of the compositions of the invention is described in U.S. Pat. No. 6,228,799, the contents of which are herein incorporated by reference and will now be described.

The first stage of the process of forming the support of this invention consists in preparing a mixture in liquid medium, generally in the aqueous phase, containing at least one cerium compound, at least one zirconium compound and a praseodymium compound. This mixture is prepared by using a zirconium solution. This zirconium solution can originate from the attack by acid on a reactant comprising zirconium. Mention may be made, as an appropriate reactant, of zirconium carbonate, hydroxide or oxide. The attack can be carried out with an inorganic acid, such as nitric acid, hydrochloric acid or sulphuric acid. Nitric acid is the preferred acid and the use of a zirconyl nitrate originating from the attack of nitric acid on a zirconium carbonate may thus be very particularly mentioned. The acid can also be an organic acid, such as acetic acid or citric acid.

According to the invention, this zirconium solution must exhibit the following characteristic. The amount of base necessary to reach the equivalent point during an acid/base titration of this solution must confirm the condition that, as a molar ratio, OH⁻/Zr≦1.65. More particularly, this ratio can be at most 1.5 and more particularly still at most 1.3. Generally, the specific surface of the composition obtained has a tendency to increase when this ratio decreases.

The acid/base titration is carried out in a known way. In order for it to be carried out under optimum conditions, a solution which has been brought to a concentration of approximately 3×10⁻² mol per liter, expressed as elemental zirconium, can be titrated. A 1N sodium hydroxide solution is added thereto with stirring. Under these conditions, the equivalent point (change in the pH of the solution) is determined in a clear-cut way. This equivalent point is expressed by the OH⁻/Zr molar ratio.

Mention may particularly be made, as cerium compounds, of cerium salts such as cerium(IV) salts, such as nitrates or ceric ammonium nitrates for example, which are particularly well suited in this instance. Ceric nitrate is preferably used. The solution of cerium(IV) salts can contain cerium in the cerous state but it is preferable for it to contain at least 85% of cerium(IV). An aqueous ceric nitrate solution can, for example, be obtained by reaction of nitric acid with a ceric oxide hydrate prepared conventionally by reaction of a solution of a cerous salt, for example cerous nitrate, and of an aqueous ammonia solution in the presence of hydrogen peroxide. Use can also be made of a ceric nitrate solution obtained according to the process of electrolytic oxidation of a cerous nitrate solution as described in the document FR-A-2,570,087, which can constitute an advantageous starting material.

It will be noted here that the aqueous solution of cerium(IV) salts can exhibit a degree of initial free acidity, for example a normality varying between 0.1 and 4N. According to the present invention, it is just as possible to use an initial solution of cerium(IV) salts effectively exhibiting a degree of free acidity as mentioned above as a solution which would have been neutralized beforehand more or less exhaustively by addition of a base, such as for example an aqueous ammonia solution or alternatively a solution of alkali metal (sodium, potassium and the like) hydroxides, but preferably an aqueous ammonia solution, so as to limit this acidity. It is then possible, in the latter case, to define in practice a degree of neutralization (r) of the initial cerium solution by the following equation:

$$r = \frac{n 3 - n 2}{n 1}$$

in which n1 represents the total number of moles of Ce(IV) present in the solution after neutralization; n2 represents the number of moles of OH⁻ ions effectively necessary to neutralize the initial free acidity introduced by the aqueous cerium(IV) salt solution; and n3 represents the total number of moles of OH⁻ ions introduced by the addition of the base. When the “neutralization” alternative form is implemented, use is made in all cases of an amount of base which absolutely must be less than the amount of base which would be necessary to obtain complete precipitation of the hydroxide species Ce(OH)₄ (r=4). In practice, the limit is therefore set at degrees of neutralization which do not exceed 1 and preferably still do not exceed 0.5.

The praseodymium compounds are preferably compounds which are soluble in water, in particular, the salts of inorganic or organic acids, for example of the sulphate, nitrate, chloride or acetate type. It will be noted that the nitrate is particularly well suited. These compounds can also be introduced in the form of sols. These sols can be obtained, for example, by neutralization by a base of a salt of these compounds.

The amounts of cerium, zirconium and praseodymium present in the mixture must correspond to the stoichiometric proportions required in order to obtain the final desired composition. The initial mixture thus being obtained, it is then heated in accordance with the second stage of the process according to the invention. The temperature at which this heat treatment, also known as thermohydrolysis, is carried out can be between 80° C. and the critical temperature of the reaction mixture, in particular between 80 and 350° C. and preferably between 90 and 200° C.

This treatment can be carried out, according to the temperature conditions used, either at normal atmospheric pressure or under pressure, such as, for example, the saturated vapour pressure corresponding to the temperature of the heat treatment. When the treatment temperature is chosen to be greater than the reflux temperature of the reaction mixture (that is to say generally greater than 100° C.), for example chosen between 150 and 350° C., the operation is then carried out by introducing the aqueous mixture containing the abovementioned species into an enclosed space (closed reactor more commonly known as an autoclave), the necessary pressure then resulting only from the heating alone of the reaction mixture (autogenous pressure). Under the temperature conditions given above, and in aqueous medium, it is thus possible to specify, by way of illustration, that the pressure in the closed reactor varies between a value greater than 1 bar (10⁵ Pa) and 165 bar (165×10⁵ Pa), preferably between 5 bar (5×10⁵ Pa) and 165 bar (165×10⁵ Pa). It is of course also possible to exert an external pressure which is then added to that resulting from the heating.

The heating can be carried out either under an air atmosphere or under an inert gas atmosphere, preferably nitrogen. The duration of the treatment is not critical and can thus vary within wide limits, for example between 1 and 48 hours and preferably between 2 and 24 hours. On conclusion of the heating stage, a solid precipitate is recovered which can be separated from its mixture by any conventional solid/liquid separation technique, such as, for example, filtration, settling, draining or centrifuging.

It may be advantageous, after the heating stage, to introduce a base, such as, for example, an aqueous ammonia solution, into the precipitation mixture. This makes it possible to increase the recovery yields of the precipitated species.

It is also possible, in the same way, to add hydrogen peroxide after the heating stage.

The product as recovered can then be subjected to washings with water and/or with aqueous ammonia, at a temperature between ambient temperature and the boiling temperature. In order to remove the residual water, the washed product can finally, optionally, be dried, for example in air, at a temperature which can vary between 80 and 300° C. and preferably between 100 and 150° C., drying being continued until a constant weight is obtained.

It will be noted that it is of course possible, after recovery of the product and optional addition of the base or of hydrogen peroxide, to repeat a heating stage as described above one or a number of times, in an identical or nonidentical way, by then again placing the product in liquid medium, in particular in water, and by carrying out, for example, heat treatment cycles.

In a last stage of the process, the recovered precipitate, optionally after washing and/or drying, is then calcined. According to a specific embodiment, it is possible, after the thermohydrolysis treatment and optionally after again placing the product in liquid medium and an additional treatment, directly to dry the reaction mixture obtained by atomization.

The calcination is carried out at a temperature generally of between 200 and 1200° C. and preferably between 300 and 900° C. This calcination temperature must be sufficient to convert the precursors to oxides and it is also chosen as a function of the temperature of subsequent use of the catalytic composition, it being taken into account that the specific surface of the product becomes smaller as the calcination temperature employed becomes higher. The duration of the calcination can, for its part, vary within wide limits, for example between 1 and 24 hours and preferably between 4 and 10 hours. The calcination is generally carried out under air but a calcination carried out, for example, under an inert gas is very clearly not excluded.

The precious metal catalyst component is impregnated into the CZP support. For example, the metals can be platinum, rhodium, palladium, ruthenium, or iridium. Rhodium or ruthenium is preferred. Reference to “impregnated” means that a precious metal-containing liquid solution is put into pores of a support. In detailed embodiments, impregnation of precious metals is achieved by incipient wetness, where a volume of diluted precious metal-containing solution is approximately equal to the pore volume of the support bodies. Incipient wetness impregnation generally leads to a substantially uniform distribution of the solution of the precursor throughout the pore system of the support.

Water-soluble compounds or water-dispersible compounds or complexes of the metal component may be used as long as the liquid medium used to impregnate or deposit the metal component onto the support does not adversely react with the metal or its compound or its complex or other components which may be present in the catalyst composition and is capable of being removed from the metal component by volatilization or decomposition upon heating and/or application of a vacuum. In some cases, the completion of removal of the liquid may not take place until the catalyst is placed into use and subjected to the high temperatures encountered during operation. Generally, both from the point of view of economics and environmental aspects, aqueous solutions of soluble compounds or complexes of the precious metals are utilized. For example, rhodium nitrate is particularly useful. During the calcination step, or at least during the initial phase of use of the catalyst, such compounds are converted into a catalytically active form of the metal or a compound thereof. In general, the precious metal component of the catalyst will comprise 0.1 to 10 wt. % as metal, based on the weight of the CZP support. More specifically, the catalyst will comprise 1 to 5 wt. % as metal, such as rhodium, based on the weight of the CZP support.

The compositions of the invention as described above or as obtained in the processes mentioned above are provided in the form of powders but they can optionally be shaped in order to be provided in the form of granules, balls, cylinders or honeycombs of variable sizes. These compositions can also be applied to any additional support commonly used in the field of catalysis, that is to say in particular thermally inert supports. This support can be chosen from alumina, titanium oxide, cerium oxide, zirconium oxide, silica, spinels, zeolites, silicates, crystalline silicoaluminium phosphates or crystalline aluminum phosphates. The compositions can also be used in catalytic systems comprising a coating (wash coat), based on these compositions and with catalytic properties, on a substrate of the metal or ceramic monolith type, for example. The coating can itself also contain a support of the type of those mentioned above. This coating is obtained by mixing the composition with the support, so as to form a suspension which can subsequently be deposited on the substrate.

The steam reforming reaction for a hydrocarbon using the reforming catalyst of the present invention shall be explained.

The raw material hydrocarbon used for this reaction includes, for example, various hydrocarbons including linear or branched saturated hydrocarbons having 1 to 16 carbon atoms such as methane, ethane, propane, butane, pentane, hexane, heptane, octane, nonane and decane, alicyclic saturated hydrocarbons such as cyclohexane, methylcyclohexane and cyclooctane, monocyclic and polycyclic aromatic hydrocarbons, city gas, LPG, naphtha and kerosene. The invention, in particular, the use of the steam reforming catalyst including the CZP support as previously described, is particularly useful in steam reforming hydrocarbons containing coke precursors. In general, hydrocarbon feeds containing olefins, aromatics and hydrocarbons of C₅ and higher yield relatively higher levels of coke during the reforming process. The catalyst of this invention yields a reduced amount of coke and consequently has improved retention of activity.

In general, when a sulfur content is present in these raw material hydrocarbons, they are preferably passed through a desulfurizing step to carry out desulfurization until the sulfur content becomes 0.1 ppm or less. If the sulfur content in the raw material hydrocarbons is more than 0.1 ppm, it causes deactivation of the steam reforming catalyst in a certain case. The desulfurizing method shall not specifically be restricted, and hydrogenating desulfurization and adsorbing desulfurization can suitably be adopted. Steam used for the steam reforming reaction shall not specifically be restricted.

In respect to the reaction conditions, the hydrocarbon amount and the steam amount may be determined so that steam/carbon (mole ratio) is 1.5 to 10, preferably 1.5 to 5 and more preferably 2 to 4. Thus, controlling of steam/carbon (mole ratio) makes it possible to efficiently obtain a product gas having a large hydrogen content.

The reaction temperature is usually 200 to 900° C., preferably 400 to 900° C. and more preferably 550 to 700° C. The reaction pressure is usually 0 to 3 MPaG.

### EXAMPLES

The CZP carrier was obtained commercially from Rhodia. The support was comprised of 55 wt. % ceria, 15 wt. % zirconia and 30 wt. % praseodymium oxide. This catalyst was tested in monolithic form where the synthesis steps involved: (1) dispersing a rhodium metal salt into the CZP carrier using incipient wetness, (2) ball milling the impregnated carrier for 16 hrs, (3) washcoating a cordierite monolith the with ball milled slurry, and (4) calcining the washcoated monolith at 525° C. for 4 hours.

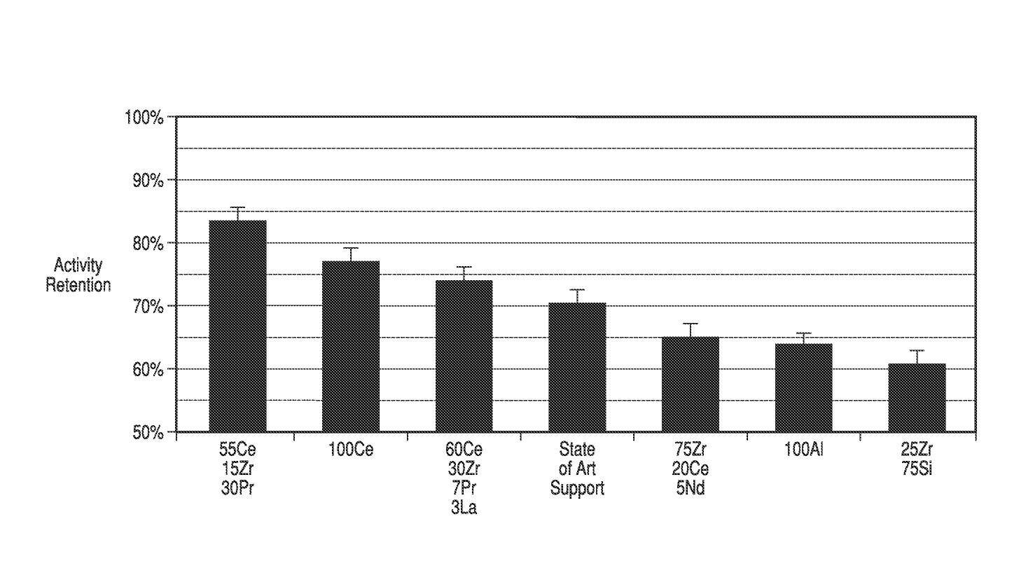

To quantify the tendency for coke accumulation and catalyst deactivation, an accelerated test was developed where a simulated fuel containing coke precursors (20% propene/propane) was steam reformed over the desired catalyst at varying reaction temperatures and steam concentrations. The results from this testing are illustrated in FIG. 1 and Table 1 set forth below. FIG. 1 (16 hrs. aging) and Table 1 illustrate the stability of the CZP mixed metal oxide combination relative to a state of the art catalyst comprising an alumina/ceria-zirconia matrix, and other mixed metal oxide combinations at a reforming temperature of 550° C. and steam/carbon ratio of 2.2. This data demonstrates the improved stability of the CZP carrier relative to the state of the art. This plot also illustrates it is the significant addition of Pr into the Ce—Zr matrix that results in the improved coke tolerance. Run 11 in Table 1 utilized a support known for a three-way automotive catalyst. The support in Run 11 had a PrOx content of 7 wt. %. As can be seen, the support of the present invention, which contains at least 10 wt. % PrOx, had improved activity retention relative to the catalyst of Run 11, see the Figure. Table 2 illustrates the stability of the CZP based catalyst compared to the state of the art catalyst described above at a varying steam concentrations (steam/carbon ratios). This data demonstrates the improved performance of the CZP based catalyst over the current state of the art. Specifically, at equal reforming conditions, the CZP based catalyst deactivates more slowly than the state of the art catalyst, particularly at lower reaction temperatures (550° C.) and lower steam/carbon ratios (2.2) where coke accumulation is a significant issue.

This invention provides a more coke tolerant catalyst that can be applied in fuel processors used to convert hydrocarbons into hydrogen for fuel cells. This new catalyst will allow the steam reformer to operate at lower reaction temperatures and steam concentrations, which will increase the efficiency of the fuel cell system. Maximizing system efficiency is critical to the large-scale successful commercialization of fuel cell systems.

TABLE 1

| | | Time On Stream (Hrs.) | | | | |
|---|---|---|---|---|---|---|
| Run | Composition | 0.17 | 0.75 | 3 | 9 | 16 |
| 1 | State of the Art | 57.9% | 50.6% | 42.1% | 33.8% | 28.7% |
| | Catalyst | 2.79 | 2.73 | 2.42 | 2.17 | 1.97 |
| | | | 0.87 | 0.73 | 0.58 | 0.50 |
| | | | 0.98 | 0.87 | 0.78 | 0.70 |
| 2 | 3Rh/Al203/ | 32.4% | 29.8% | 24.6% | 19.6% | 17.2% |
| | Ce,Zr,O/CeO2/ | 1.87 | 1.77 | 1.55 | 1.35 | 1.25 |
| | stblzd | | 0.92 | 0.76 | 0.61 | 0.53 |
| | | | 0.95 | 0.83 | 0.72 | 0.67 |
| 3 | 3Rh/Al203/ | 45.7% | 42.4% | 37.0% | 31.7% | 28.9% |
| | Ce,Zr,O/CeO2/ | 2.51 | 2.36 | 2.16 | 1.92 | 1.79 |
| | stblzd | | 0.93 | 0.81 | 0.69 | 0.63 |
| | | | 0.94 | 0.86 | 0.76 | 0.71 |
| 4 | 3Rh/CeZrO | 34.5% | 34.2% | 32.5% | 29.2% | 27.9% |
| | | 2.66 | 2.64 | 2.54 | 2.37 | 2.29 |
| | | | 0.99 | 0.94 | 0.85 | 0.81 |
| | | | 0.99 | 0.96 | 0.89 | 0.86 |
| 6 | 3Rh/CZP,La | 45.8% | 44.3% | 41.3% | 35.7% | 33.8% |
| | | 3.00 | 2.86 | 2.61 | 2.36 | 2.21 |
| | | | 0.97 | 0.90 | 0.78 | 0.74 |
| | | | 0.95 | 0.87 | 0.79 | 0.74 |
| 7 | 3Rh/CeZrO | 36.7% | 33.0% | 28.8% | 23.3% | 20.4% |
| | | 2.20 | 2.06 | 1.83 | 1.60 | 1.44 |
| | | | 0.90 | 0.78 | 0.63 | 0.56 |
| | | | 0.94 | 0.83 | 0.73 | 0.65 |
| 8 | 4Pt/Al203/ | 8.1% | 6.6% | 4.3% | 2.9% | 2.0% |
| | Ce,Zr,O/CeO2/ | 0.70 | 0.55 | 0.37 | 0.22 | 0.16 |
| | stblzd | | 0.81 | 0.53 | 0.36 | 0.24 |
| | | | 0.78 | 0.53 | 0.32 | 0.23 |
| 9 | 3Rh/MnO2 | 6.9% | 4.2% | 2.7% | 1.9% | 1.4% |
| | | 0.57 | 0.31 | 0.19 | 0.13 | 0.10 |
| | | | 0.60 | 0.39 | 0.27 | 0.20 |
| | | | 0.54 | 0.33 | 0.23 | 0.17 |
| 10 | 3Rh/CeO2 | 11.1% | 8.8% | 6.4% | 4.7% | 3.4% |
| | | 0.77 | 0.62 | 0.45 | 0.35 | 0.25 |
| | | | 0.80 | 0.58 | 0.43 | 0.31 |
| | | | 0.80 | 0.59 | 0.45 | 0.33 |
| 11 | 3Rh/Ce,Zr,Pr, | 39.6% | 35.8% | 31.2% | 27.7% | 26.3% |
| | La,O | 2.67 | 2.46 | 2.29 | 2.17 | 2.05 |
| | | | 0.90 | 0.79 | 0.70 | 0.66 |
| | | | 0.92 | 0.86 | 0.81 | 0.77 |
| 12 | 3Rh/Al203 | 31.1% | 28.1% | 23.9% | 19.1% | 16.9% |
| | | 1.67 | 1.54 | 1.35 | 1.19 | 1.07 |
| | | | 0.90 | 0.77 | 0.61 | 0.54 |
| | | | 0.92 | 0.81 | 0.71 | 0.64 |

KEY Time on Stream Results
Row#1 = Fuel Conversion
Row#2 = Hydrogen Yield
Row#3 = Relative Change in Fuel Conversion
Row#4 = Relative Change in Hydrogen Yield

TABLE 2

| | | | | Time On Stream (Hrs.) | | | | |
|---|---|---|---|---|---|---|---|---|
| Run | Composition | Temp | S/C | 0.17 | 0.75 | 3 | 9 | 16 |
| 13 | 3Rh/CZP | 550 | 2.2 | 35% | 34% | 32% | 29% | 28% |
| | | | | 2.66 | 2.64 | 2.54 | 2.37 | 2.29 |
| | | | | | 99.1% | 94.1% | 84.6% | 80.8% |
| | | | | | 99.2% | 95.5% | 89.3% | 86.1% |
| 14 | 3Rh/CZP | 550 | 2.2 | 36% | 34% | 32% | 28% | 27% |
| | | | | 2.74 | 2.64 | 2.50 | 2.33 | 2.21 |
| | | | | | 95.3% | 88.6% | 79.8% | 7.57% |
| | | | | | 96.1% | 91.1% | 84.8% | 80.6% |
| 15 | 3Rh/CZP | 550 | 2.2 | 34% | 33% | 29% | 26% | 24% |
| | | | | 2.36 | 2.32 | 2.17 | 1.94 | 1.76 |
| | | | | | 98.4% | 86.7% | 77.7% | 72.1% |
| | | | | | 98.3% | 92.3% | 82.3% | 74.8% |
| 16 | 3Rh/CZP | 550 | 3 | 41% | 42% | 40% | 35% | 34% |
| | | | | 3.23 | 3.22 | 3.09 | 2.88 | 2.81 |
| | | | | | 102.8% | 97.5% | 86.5% | 82.9% |
| | | | | | 99.7% | 95.6% | 89.2% | 86.9% |
| 17 | 3Rh/CZP | 550 | 3 | 38% | 38% | 37% | 36% | 34% |
| | | | | 3.27 | 3.21 | 3.01 | 2.83 | 2.74 |
| | | | | | 98.5% | 97.6% | 93.9% | 89.0% |
| | | | | | 98.1% | 92.2% | 86.6% | 83.8% |
| 18 | 3Rh/CZP | 550 | 3.6 | 53% | 52% | 49% | 47% | 47% |
| | | | | 4.11 | 4.00 | 3.85 | 3.67 | 3.69 |
| | | | | | 96.5% | 91.7% | 87.4% | 88.1% |
| | | | | | 97.4% | 93.8% | 89.4% | 89.8% |
| 19 | 3Rh/CZP | 625 | 2.2 | 54% | 53% | 51% | 46% | 43% |
| | | | | 3.53 | 3.49 | 3.38 | 3.23 | 3.09 |
| | | | | | 99.2% | 95.0% | 85.0% | 80.7% |
| | | | | | 98.9% | 95.9% | 91.6% | 87.8% |
| 20 | 3Rh/CZP | 625 | 2.2 | 45% | 45% | 43% | 39% | 36% |
| | | | | 3.38 | 3.40 | 3.33 | 3.17 | 2.96 |
| | | | | | 100.7% | 96.7% | 87.6% | 80.6% |
| | | | | | 100.4% | 98.6% | 93.8% | 87.6% |
| 21 | 3Rh/CZP | 625 | 3 | 58% | 54% | 50% | 52% | 51% |
| | | | | 4.23 | 3.82 | 3.68 | 3.97 | 3.97 |
| | | | | | 93.6% | 87.4% | 89.3% | 89.1% |
| | | | | | 90.2% | 86.8% | 93.8% | 93.6% |
| 22 | 3Rh/CZP | 625 | 3.6 | 70% | 70% | 67% | 69% | 65% |
| | | | | 5.18 | 5.21 | 5.00 | 5.07 | 4.90 |
| | | | | | 101.2% | 96.7% | 99.6% | 93.6% |
| | | | | | 100.5% | 96.5% | 97.8% | 94.5% |
| 23 | 3Rh/CZP | 625 | 3.6 | 104% | 104% | 98% | 98% | 95% |
| | | | | 5.04 | 5.09 | 4.83 | 4.90 | 4.80 |
| | | | | | 100.5% | 95.1% | 94.7% | 92.0% |
| | | | | | 101.0% | 95.9% | 97.4% | 95.4% |
| 24 | State of the Art | 550 | 2.2 | 41% | 37% | 31% | 25% | 21% |
| | | | | 2.33 | 2.17 | 1.94 | 1.69 | 1.47 |
| | | | | | 89.3% | 75.1% | 61.0% | 50.9% |
| | | | | | 9.32% | 83.2% | 72.3% | 62.9% |
| 25 | State of the Art | 550 | 2.2 | 44% | 41% | 34% | 26% | 22% |
| | | | | 2.49 | 2.42 | 2.16 | 1.80 | 1.63 |
| | | | | | 94.1% | 77.7% | 58.0% | 50.1% |
| | | | | | 97.2% | 87.0% | 72.4% | 65.6% |
| 26 | State of the Art | 550 | 2.2 | 45% | 40% | 35% | 27% | 25% |
| | | | | 2.29 | 2.16 | 1.87 | 1.58 | 1.46 |
| | | | | | 90.6% | 78.7% | 61.5% | 56.7% |
| | | | | | 94.4% | 81.7% | 69.0% | 64.1% |
| 27 | State of the Art | 550 | 3 | 71% | 67% | 56% | 44% | 38% |
| | | | | 3.22 | 3.16 | 2.88 | 2.57 | 2.36 |
| | | | | | 94.8% | 78.9% | 62.2% | 53.6% |
| | | | | | 98.1% | 89.3% | 79.8% | 73.3% |
| 28 | State of the Art | 550 | 3 | 69% | 64% | 55% | 46% | 44% |
| | | | | 2.98 | 2.96 | 2.79 | 2.48 | 2.40 |
| | | | | | 91.8% | 79.9% | 66.4% | 63.3% |
| | | | | | 99.3% | 93.6% | 83.0% | 80.4% |
| 29 | State of the Art | 550 | 3.6 | 71% | 68% | 63% | 56% | 51% |
| | | | | 3.58 | 3.50 | 3.27 | 3.08 | 2.92 |
| | | | | | 96.0% | 88.4% | 79.1% | 71.4% |
| | | | | | 97.8% | 91.5% | 86.2% | 81.6% |
| 30 | State of the Art | 625 | 2.2 | 84 | 82% | 73% | 60% | 52% |
| | | | | 3.64 | 3.55 | 3.37 | 3.09 | 2.93 |
| | | | | | 97.0% | 86.2% | 71.1% | 61.3% |
| | | | | | 97.6% | 92.6% | 84.8% | 80.4% |
| 31 | State of the Art | 625 | 3 | 92 | 91% | 85% | 75% | 71% |
| | | | | 4.03 | 4.08 | 3.95 | 3.75 | 3.64 |
| | | | | | 99.7% | 92.9% | 81.7% | 77.3% |
| | | | | | 101.1% | 97.9% | 92.9% | 90.3% |
| 32 | State of the Art | 625 | 3 | 98% | 99% | 98% | 95% | 86% |
| | | | | 4.49 | 4.50 | 4.51 | 4.46 | 4.25 |
| | | | | | 101.2% | 99.7% | 96.3% | 87.9% |
| | | | | | 100.3% | 100.4% | 99.3% | 94.7% |
| 33 | State of the Art | 625 | 3.6 | 108% | 110% | 112% | 103% | 96% |
| | | | | 4.75 | 4.74 | 4.96 | 4.69 | 4.54 |
| | | | | | 101.2% | 103.3% | 95.2% | 88.9% |
| | | | | | 99.9% | 104.4% | 98.7% | 95.6% |

KEY Time on Stream Results
Row#1 = Fuel Conversion
Row#2 = Hydrogen Conversion
Row#3 = Relative Change in Fuel Conversion
Row#4 = Relative Change in Hydrogen Yield

1. A method of producing hydrogen by steam reforming a hydrocarbon feed in the presence of a steam reforming catalyst, said catalyst consisting essentially of a precious metal contained on a ceria-zirconia-praseodymium oxide support.

2. The method of claim 1, wherein said precious metal is rhodium

3. The method of claim 1, wherein said precious metal is ruthenium.

4. The method of claim 2, wherein said rhodium is present in amounts of from 0.1 to 10 wt. % based on the weight of the support.

5. The method of claim 1, wherein said support can be characterized as CeₓZr_{y}Pr_{z}O₂, wherein z is a value between 0.02 and 0.5, the x/y ratio is between 1 and 19 and x+y+z=1.

6. The method of claim 5, wherein z ranges from 0.1 to 0.3.

7. The method of claim 5, wherein z ranges from 0.2 to 0.3.

8. The method of claim 5, wherein the x/y ratio is between 1 and 9.

9. The method of claim 7, wherein said x/y ratio is between 1.5 and 4.

10. The method of claim 5 wherein said precious metal is rhodium.

11. The method of claim 5 wherein said precious metal is ruthenium.

12. The method of claim 10, wherein said rhodium is present in amounts of from 0.1 to 10 wt. % based on the weight of the support.

13. The method of claim 1, wherein said hydrocarbon feed contains coke precursors.

14. The method of claim 5, wherein said hydrocarbon feed contains coke precursors.

15. The method of claim 10, wherein said hydrocarbon feed contains coke precursors.

16. The method of claim 1, wherein said steam reforming of said hydrocarbon feed is at a reaction temperature of between 200 to 900° C.

17. The method of claim 16, wherein said steam reforming of said hydrocarbon feed is at a pressure of 0 to 3 MPaG.

18. The method of claim 1, wherein the steam to carbon mole ratio of the steam and hydrocarbon feed reactants is 1.5 to 10.

19. The method of claim 18, wherein the steam to carbon mole ratio of the steam and hydrocarbon feed reactants is 2 to 4.

20. A catalyst for steam reforming a hydrocarbon feed to hydrogen consisting essentially of rhodium contained on a support characterized as CeₓZr_{y}Pr_{z}O₂ wherein z is a value between 0.1 and 0.5, the x/y ratio is between 1 and 19 and x+y+z=1, wherein said rhodium is present in amounts from 0.1 to 10 wt. % based on the weight of said support.
